(19) United States
(12) Patent Application Publication
(10) Pub. No.: US 2018/0349932 A1
(43) Pub. Date: Dec. 6, 2018

(54) METHODS AND SYSTEMS FOR DETERMINING PERSONA OF PARTICIPANTS BY THE PARTICIPANT USE OF A SOFTWARE PRODUCT

(71) Applicant: salesforce.com, inc., San Francisco, CA (US)

(72) Inventors: Amy Catherine Lee, San Mateo, CA (US); Joseph Andolina, Castro Valley, CA (US); Glenn Sorrentino, Oakland, CA (US)

(73) Assignee: salesforce.com, inc., San Francisco, CA (US)

(21) Appl. No.: 15/609,389

(22) Filed: May 31, 2017

(51) Int. Cl. G06Q 30/02; G06N 99/00

(52) U.S. Cl. CPC G06Q 30/0203; G06N 99/005

(57) ABSTRACT

A method and system for creating an app consistent with an arrangement of an object and an associated template using a platform. The method includes downloading a plurality of templates for creating an app and each of the templates contains identification information for associating a template with at least one of a plurality of online components. Then, defining an online component by selecting the associated template and an object for an online component selection, wherein the object includes at least multimedia data for display on the graphic app. Finally, capturing together by video both the object and the associated template with the identification information to match to an online component which corresponds to the identification information and to create the online component from the match together with the multimedia data in a manner consistent with the arrangement of the object and associated template when captured by video.

### TECHNICAL FIELD

Embodiments of the subject matter described herein relate generally to image processing applications. More particularly, embodiments of the subject matter relate to methods and systems to capture in video viewed objects with data arranged with downloaded templates with identification markings, to match the captured objects with online components by the identification markings extracted therein and to create in real-time an app composed of the online components displaying the object data in a manner consistent with the physical object arrangement during the video capture.

### BACKGROUND

Currently, the process to create an app is performed in its entirety for the most part online. For users that have preferences for performing tasks off line with physical interactions in the app creation process, such users are left with little choices as the present paradigm only allows for the entire app creation process to be performed online. This is because when considering the app creation process, app developers have not focused on alternative off line steps in the app creation process rather the modus operandi of these developers has been for creating apps with limits in the online developmental steps only. That is, app developers generally have built processes enabling users to select predesigned or preconfigured app templates and have touted these implementations as cutting down the steps of online development and subsequent overall development time. However, these predesigned or preconfigured templates have limited customizable flexibility and do not always have the arrangements and features that a user desires. Further, a user can spend time and fruitless energy searching for the appropriate templates and still may have to spend more significant time editing the templates for the particular needs wanted by the user.

Accordingly, it is desirable to insert off line steps for app creation by a user to allow for flexibility in customization of arrangements of components on a webpage while still maintaining a variety of ways of displaying component data and allowing for user interactions. In one instance, it is desired for the user in the app creation process to have physical interactive capabilities for selecting and arranging templates with objects by hand to create an app.

In other instances, it is desired to enable by physical arrangements of the user, the design of components of a webpage with data for displaying in real-time the component data where the components and arrangements of the components on a physical flat surface are captured by video from a mobile device to be mirrored in a display on a webpage within a cloud platform. Further, it is desired that when changes in the physical arrangements of the components are made by the user and these changes in arrangements are viewed and captured; the changed results in the arrangements are shown in real-time on the webpage to the user.

Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exemplary component and device diagram illustrating the app creation process in accordance with an embodiment;

FIG. 2 is an exemplary diagram illustrating a template in the app creation process in accordance with an embodiment;

FIG. 3 is an exemplary diagram illustrating components on a webpage in the app creation process in accordance with an embodiment;

FIG. 4 is an exemplary flowchart illustrating the applications in the app creation process in accordance with an embodiment;

FIG. 5 is an exemplary flowchart illustrating a system of components in the app creation process accordance with an embodiment; and

FIG. 6 is a schematic block diagram of a multi-tenant computing environment for use in conjunction with the app creation process in accordance with an embodiment.

### DETAILED DESCRIPTION

Often users want a hands-on experience when creating an app. That is, there are users who simply enjoy performing physical tasks and adjusting a body of work by physical touch. The focus, as explained earlier, on app creation has for the most part been on performing the steps of the app creation on-line and with no physical manipulations by hand of the design of the app display using, for example, a set of physical building blocks to create the app. Hence, the present disclosure provides methodology to include physical hand manipulations of component building blocks in the app creation process and in so doing provides another way of artistic impression for the user to express themselves when creating an app. Moreover, some users have reluctance to create apps in the entirety on-line due to the user's inhibitions with the use of computer technology. Therefore, by enabling part of the app creation process to be performed off-line allows for greater degrees of comfort and lessening or a reduction of user inhibitions or other such cognitive user obstacles or stumbling blocks in using computer technologies to create an app.

It is desirable for an automated process using an app or platform or both in conjunction with a network to identify off line components of objects and templates, to match the off-line components with online components in a manner, and to allow for the display of the data of the objects and the object data to include all kinds of multimedia data for display.

It is desirable to have additional information added to the components to augment the object data displayed in manner that allows for augmentation of the display data with data derived from third party sources including artificial intelligent and machine learning applications.

It is desirable to store the identified components with display data in a local or multi-tenant database for retrieval and for use in future apps created and for real-time information to be added to the object data using search agents of the databases and other social sites.

It is desirable to exchange information using a multi-tenant platform for sharing and augmenting object data during app creation and use. In an exemplary example, it is desired to configure the app to enable app to access information from a database associated with the multi-tenant platform relating to object data identified during use.

In addition, it is desirable to initiate computer vision software applications by a user when arranging the objects for capture and to execute the computer vision software applications, which may be hosted by the server or a mobile device, for detecting and determining attributes of the object.

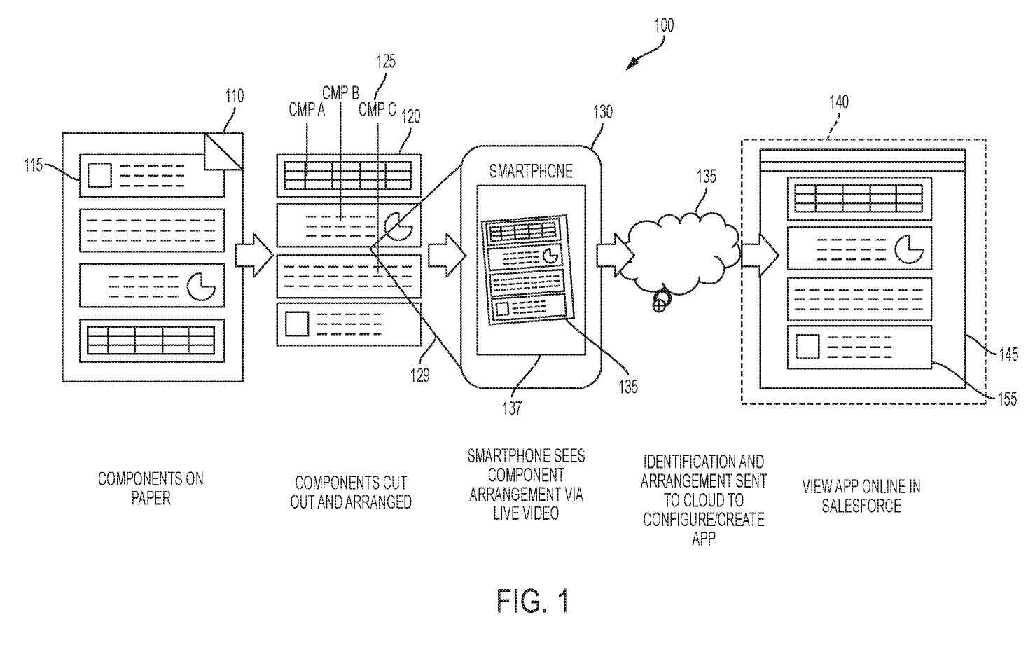

With a reference to FIG. 1, FIG. 1 is an exemplary component and device diagram in accordance with an embodiment. The template 110 is downloaded and in instances may be printed out. The template 110 includes a set of components 115. The components 115 can be considered off line components. In an exemplary embodiment, a user may physically printout the template 110 containing the set of components 115. Next, the user may use a cutting instrument or the like to separate the set of components 115. Each of the components 115 from the set of separate components 125 are then constructed to form a webpage by the user by the physical steps of manually dividing the printout into individual components 120 which may be labeled a component A, a component B and a component C. The separate components 125 are arranged or placed together by the user on a flat surface in a manner mimicking a set of online components 135 that form a webpage and are further captured by a camera (not shown) directed by the user with a field of view 129 of the set of components 125. The camera of the mobile device 130 captures the components 125 by video and renders the captured components in an arrangement consistent or mimicking the arrangement which the user has physically by hand arranged of the cut outs of the individual components 120 of component A, component B and component C. The user may in real time view the captured video on a display 137 of the mobile device 130.

By the user viewing the collection of components on the display 137 of the mobile device 130 during the video capture of the arrangement of the set of separate components 120 collated together by the user, the user can see a preview of a webpage to be created almost instantaneously and make ascertainments on how the separate components 125 fit together in locations on a webpage. In other words, the video capture provides an instantaneous view of the look and feel of the arrangement of the separate components 125 which enables the user to determine if she or he likes the arrangement. Further, the user during the video capture can change the arrangement of the separate components 125 by hand to meet the user liking and see the changes on the captured video on the display 137 of the mobile device 130 in real-time. That is, the set of components 125 shown in the video on the display 137 of the mobile device 130 gives the user without any significant processing or latency time an immediate on demand understanding by a preview display of the components 125 placed into a webpage type frame by the user as to how the webpage will eventually appear on a display 137 of a mobile device or how the created webpage will appear on other devices. In instances, the user may desire to make changes in the arrangement of the separate components 125 and the video capture provides a means in real-time for previews of the changes whether significant or infinitesimal to be seen by the user. For example, the user may want to add components or may want to remove components, in this manner the user can create a webpage using a greater or a lesser number of cutouts of the components 125 placed in a non-virtual webpage arrangement that will be processed by the app at a later stage and virtualized into a virtual webpage. Also, further along the processing pipeline in the app creation, augmented material can be added to the virtualized webpage retrieved from third party databases.

After the video capture of the separate components 125 is performed, the video is uplinked or streamed via a network cloud to a server which is hosting the app platform (not shown). The webpage by a series of image processing applications creates an app with the template components earlier selected. The set of components 125 previously captured are reconfigured using the identification information associated with the components and processed in a manner to form a webpage 145. The positional information i.e. X, Y coordinates in the captured video for the separate components 125 are scaled or matched to corresponding sets of coordinates in the webpage to position in the appropriate locations of the corresponding online set of components in the webpage 155. In other words, the webpage displays a corresponding or mirror arrangement of components that the user has initially put together with the components 125.

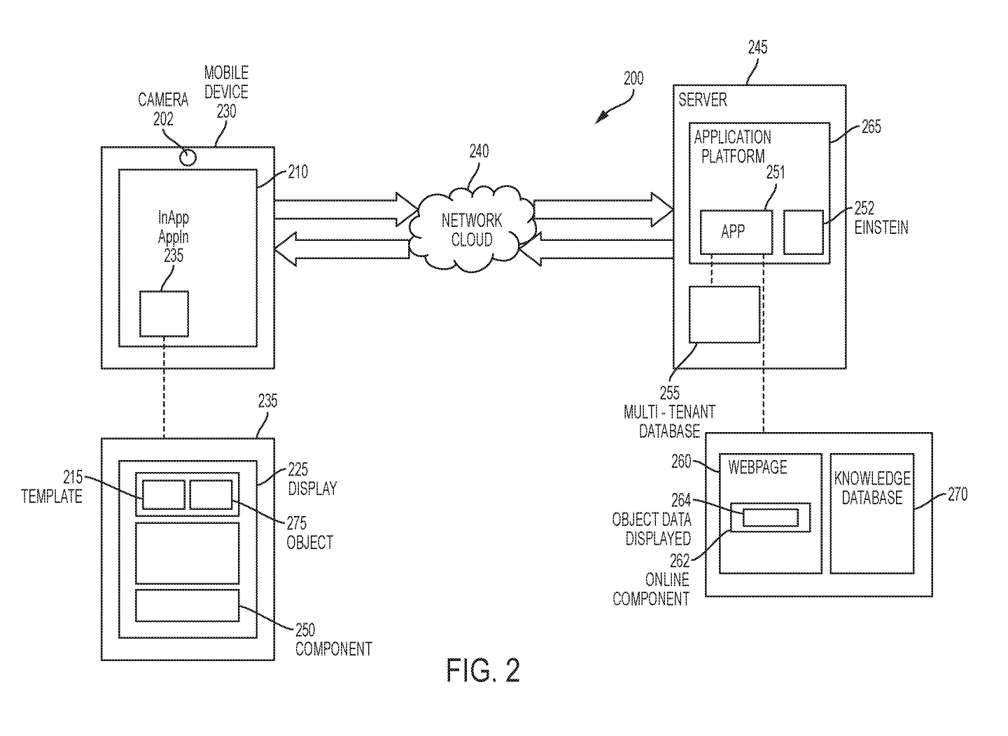

With a reference to FIG. 2, FIG. 2 is an exemplary client and app platform of a functional diagram illustrating the app creation process in accordance with an embodiment. A cloud based network system or platform may be used and includes a mobile device 230 communicating via a network cloud 240 to a server 245 for supporting an app which operates on-demand by communicating via the network cloud 240 to the mobile device 230 and with a hosted app platform on a server 245. The network cloud 240 can include interconnected networks including both wired and wireless networks for enabling communications of the mobile device 230 via a mobile client 210 to the server app 251 hosted by server 245. For example, wireless networks may use a cellular-based communication infrastructure that includes cellular protocols such as code division multiple access (CDMA), time division multiple access (TDMA), global system for mobile communication (GSM), general packet radio service (GPRS), wide band code division multiple access (WCDMA) and similar others. Additionally, wired networks include communication channels such as the IEEE 802.11 standard better known as Wi-Fi®, the IEEE 802.16 standard better known as WiMAX®, and the IEEE 802.15.1 better known as BLUETOOTH®. The network cloud 240 allows access to communication protocols and application programming interfaces that enable real-time video streaming and capture at remote servers over connections. As an example, this may include protocols from open source software packages for real-time video capture and streaming over a cloud based network system as described here.

In an exemplary embodiment, the web real-time Communication “WebRTC” can be used in the video capture process over the network cloud 240. WebRTC is an open source software package for real-time video streaming and video capture to a remote server on the web, can depending on the version be integrated in the Chrome, IOS, Explorer, Safari and other browsers for video capture and streaming as well as other communications with a mobile camera 202. Additionally, WebRTC can enable in-app video streaming and capture and related communications through different browsers through a uniform standard set of APIs. Hence, the cloud based network system allows for access for the video and related information with providers of WebRTC during the on-demand video capture and streaming in in-app applications such as a video streaming or video uploading captured by an in-app application 235 used in a mobile client 210.

The mobile device 200 includes the mobile client 210 which may use a mobile software development kit “SDK” platform. This SDK platform can provide one step activation of an on-demand services via the in-app application 235 such as shown here of the mobile client 210 for activating the on-demand service such as the app create method of the present disclosure. The mobile device 200 may include any mobile or connected computing device including “wearable mobile devices” having an operating system capable of running mobile apps individually or in conjunction with other mobile or connected devices. Examples of “wearable mobile devices” include GOOGLE® GLASS™ and ANDROID® watches. Additionally, connected device may include devices such as cars, jet engines, home appliances, tooth brushes, light sensors, air conditioning systems. Typically, the device will have display and camera 202 capabilities such as a display screens and may have associated keyboard functionalities or even a touchscreen providing a virtual keyboard and buttons or icons on a display. Many such devices can connect to the internet and interconnect with other devices via Wi-Fi, Bluetooth or other near field communication (NFC) protocols. Also, the use of cameras integrated into the interconnected devices and GPS functions can be enabled.

The mobile client 210 may additionally include other in-app applications as well as SDK app platform tools and further can be configurable to enable downloading and updating of SDK app platform tools. In addition, the mobile client 210 uses an SDK platform which may be configurable for a multitude of mobile operating systems including ANDROID®, APPLE® iOS, GOOGLE® ANDROID®, Research in Motion's BLACKBERRY OS, NOKIA's SYMBIAN, HEWLET_PACKARD®'s WEBOS (formerly PALM® OS) and MICROSOFT®'s WINDOWS Phone OS etc . . . .

The in-app application 235 of the mobile client 210 provided on the SDK platform can be found and downloaded by communicating with an on-line application market platform for apps and in-apps which is configured for the identifying, downloading and distribution of apps which are prebuilt. One such example is the SALESFORCE APPEXCHANGE® which is an online application market platform for apps and in-apps where the downloading, and installing of the pre-built apps and components such as an in-app application 235 for the mobile client 210 with app creation features can be downloaded.

In addition, these on-line application market platforms include “snap-in” agents for incorporation in the pre-built apps that are made available. The in-app application 235 may be configured as a “snap-in” agent where the snap-in agent is considered by the name to be a complete SDK packages that allows for “easy to drop” enablement in the mobile client 210 or in webpages.

The server 245 acts as a host and includes the server app 251 that is configured for access by an application platform 265. The application platform 265 can be configured as a platform as a service (“PaaS) that provides a host of features to develop, test, deploy, host and maintain-applications in the same integrated development environment of the application platform. Additionally, the application platform 265 may be part of a multi-tenant architecture where multiple concurrent users utilize the same development applications installed on the application platform 265. Also, by utilizing the multi-tenant architecture in conjunction with the application platform 265 integration with web services and databases via common standards and communication tools can be configured. As an example, SALESFORCE SERVICECLOUD® is an application platform residing on the server 245 that hosts the server app 251 and may host all the varying services needed to fulfil the application development process of the server app 251. The SALESFORCE SERVICECLOUD® as an example, may provide web based user interface creation tools to help to create, modify, test and deploy different UI scenarios of the server app 251.

The application platform 265 includes applications relating to the server app 251. The server app 251 is an application that communications with the mobile client 210, more specifically provides linking via the WebRTC to the mobile client 210 for video capture and streaming to the server 245. The component 250 may include other applications in communication for accessing a multi-tenant database 255 as an example, in a multi-tenant database system. In addition, the component 250 may configurable to include UIs to display the webpage created or potentially alternative webpage configurations for selection. In an exemplary embodiment, the display of the webpage 260 which present a similar view in the app user interface of the application of the mobile device. The SALESFORCE SERVICECLOUD® platform is an application platform 265 that can host applications of a component 250 for communication with an in-app application 235 of the mobile client 210.

With continuing reference to FIG. 2, the display of the webpage 260 of the online component 262 includes object data 264 displayed by the online component 262. Additionally, image layering functions may be selected by the user. Additionally, the application platform 265 has access to other databases for information retrieval which may include a knowledge database 270 that has artificial intelligence functionality 252. In an exemplary embodiment. The SALESFORCE® EINSTEIN™ computer vision app may include image recognition functionality that can be used with data from a SALESFORCE® app of an online component 262 and allows for training of deep learning models to recognize and classify images using the SALESFORCE® EINSTEIN™ computer vision app's API for Apex or a Heroku add-on.

In addition, the user can search for the answers using the knowledge database 270 which may be part of the multi-tenant database architecture allowing for communication with the component 250 and other mobile clients 210. The knowledge database 270 may include an object image repository configured to the allow the user to browse for information relating to the object image and send that information to the webpage 260. In addition, the application platform 265 can access a multi-tenant database 255 which is part of the multi-tenant architecture. The multi-tenant database 255 allows for enterprise customer access and the application platform 265 may be given access to the multi-tenant database dependent upon differing factors such as a session ID associated with the app creation session.

With a reference to FIG. 2, FIG. 2 is an exemplary mobile device diagram illustrating the app creation process in accordance with an embodiment. The mobile device 230 includes the template 215 which hosts the in-app application which may be a “snap-in” agent with an UI configure like button for initiating or terminating an app execution executing varies items of the template 215, a display 225 with the button UI, an object 275 within the display. While the display 225 is illustrated with the object 275 and template 215, the display 225 may also include a UI, other types of media i.e. any kind of information that can be viewed or is transmittable by apps. The template 215 may reside on a host such as a mobile device 230 which is different and therefore can be considered agnostic and configurable to the mobile device 200 which performs the hosting. Additionally, the template 215 can be configured to reside in part or be presented in part on other interconnected devices. An example of this multi-device hosting would be interconnections of smart phones coupled with wearable devices were the display maybe found on an interconnected device or both the mobile and interconnected device.

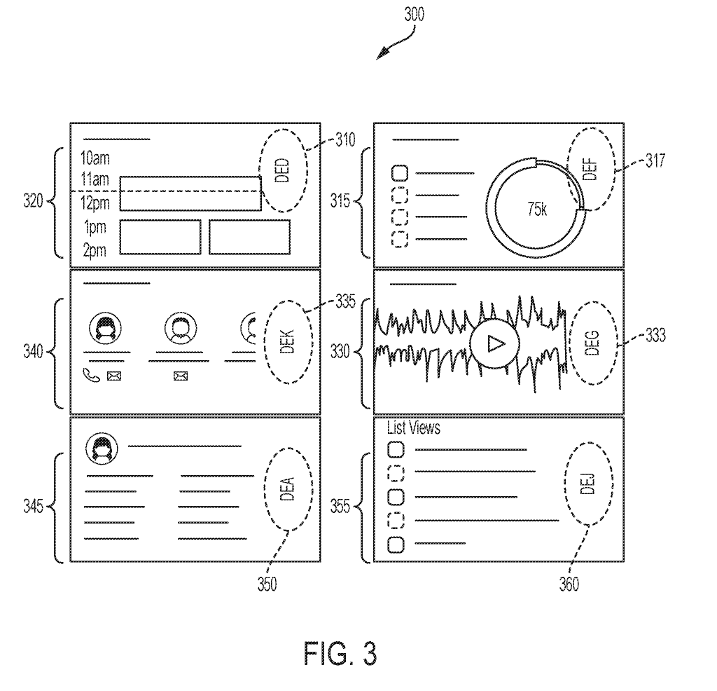

With a reference to FIG. 3, FIG. 3 is an exemplary schematic diagram illustrating a template used in the app create process in accordance with an embodiment. FIG. 3 illustrates a set of templates 300 that are downloaded by a user from an app and in instances printed out. While the set of templates 300 are represented as index like card shape cutouts, the set of templates 300 are not limited to this size and shape. Alternate types of templates are feasible of different sizes and shapes as well as identification markings. Further, the templates may be homogenous in size or shape or may be different and still be feasible for use in the app creation process.

In an exemplary embodiment, template 320 includes identification information with the identification lettering or readable text of “DED” 310. The identification lettering or readable text “DED” is of sufficient size and contrast with the background that using computer vision technologies, more specifically optical character recognition (OCR) applications, the identification lettering can be detected and recognized by a camera of a mobile device or similar kind of device. Further, the camera using OCR applications may recognize multiple identification information lettering of sets of templates at once or may capture the information for recognition processing at another time. That is the camera may capture the identification in raw image data, store the raw image data and process the identification information when retrieving the raw image data. While the sets of templates 300 shows the identification information as lettering, alternate types of identification nomenclature or type are useable. For example, the identification may be marking represented by bar codes, 2D data codes, different textual or numbering codes, etc. which are processed.

The template 315 includes identification information “DEF” 317 which are processed by OCR or related applications and matched on the server side to generate an online component related to displaying temperature data as shown in the template 315. In template 340, conferencing information for an HTML webpage having a component is shown of a user with a calling and email function incorporated. The template 340 is identified by the reference code “DEK” 335 which enables the application on the server side accessing a virtual table with each of the reference codes and the associated component functionality linked, to match the reference code with the appropriate functionality. In another exemplary embodiment, a template 330 is shown with a reference code “DEG” which is tied to an online component for generating, recording or streaming audio. The template 330 may be linked to an online component allowing for multiple types of audio to be played including compressed, lossy compressed, and uncompressed files. In addition, audio formats that may be played may include MP3, WAV, MPEG-4 and the audio file display of the template 330 is not limited to an analog type graph but may also include digital signal representations of the audio streamed or audio file played etc. In another embodiment, template 345 includes contact information in an HTML file component configured display that may be linked to a database of contact and meta data associated with the contacts. One common, data repository of contact information is email contact databases such as GMAIL®, MICROSOFT OFFICE OUTLOOOK® that may be accessible with plugins linked to online components matched to the reference code “DEA” 350 of the template 345. Additionally, the template 355 shows a list of views linked to online components monitoring metrics and access to a website using the reference code “DEJ” 360 to generate the appropriate online component configuration.

In an exemplary embodiment, a link listing from the template reference code capture can be uploaded in a serialized form and include the following: graph of list components, list of account components, related components, and related documents. This configuration may be serialized as an array ID as follows: [graphlistcomp, accountlistcomp, relatedcontactscomp, relateddocscomp] and sent to the remote server via the cloud for processing.

In additional, while the set of templates 300 shows a limited number of component types and displaying a limited number of multimedia for user interaction, numerous other kinds of multimedia may be associated with a template including video which is streamed and captured. That is, the templates may include in-app applications and may use “snap-in” agent various types of UI configurations. For example, in an exemplary embodiment, a template may include a button for initiating or terminating an on-demand video-chat communications from the webpage. The in-app application in this instance may be SALESFORCE® SERVICE SOS® hosted by the SALESFORCE® SDK which can be considered the in-app component for the webpage. The camera of the mobile device having a display connected to the in-app component of the webpage hosted on the SALESFORCE SERVICECLOUD® platform. In this case, the template by use of the WebRTC provides real-time multimedia applications (i.e. video-chat communication) on the web, without requiring plugins, downloads or installs. WebRTC consists of several interrelated APIs and protocols which are arranged intermingling to enable signaling and connecting to a server from a different platform mobile device. The communication of information flow is sent bi-directionally to and from the WebRTC provider to the mobile client and to the webpage.

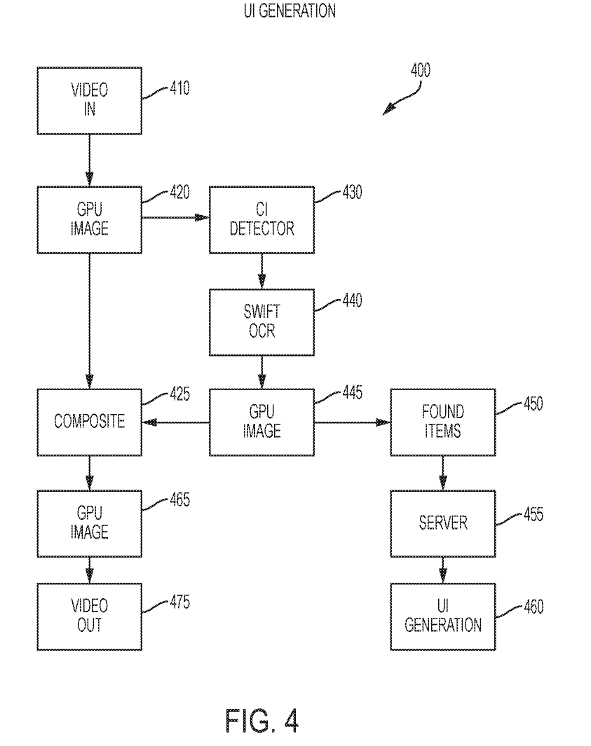

With a reference to FIG. 4 there is illustrated a flowchart of the process for object recognition in the app create method of the present disclosure. A multi-stage processing is performed by calling a series of procedures of computer vision applications to perform the image capture of the selected image of the object and extract the associated packet data to create an object block. There are a host of available libraries that provide such processing tools for such computer vision applications. In an exemplary embodiment, the video is inputted at 410 and received in using an open source GPUimage framework at 420. Then using SWIFT™ detection applications the object image and reference codes of the templates are extracted. At 430, a CIDetector for the object detection is executed on the client side and the X, Y coordinates of the template are determined. In addition, features of the object image may also be determined. In an embodiment, on the iOS platform, the video captured in a session may be called an VideoCaptureSession, which mediates and coordinates the flow between inputs (VideoCaptureInput objects) and outputs (VideoCaptureOutput objects) to perform real-time input capture and rendering. The CIDetector for detecting the object uses image processing to look for specific features in an image. The CIDetector object may be instantiated with type CIDetectorObjects or the user mobile device may request the features and capabilities associated with the object from the server application platform system. Next, SWIFTOCR to convert aspects of the image captured by video into recognizable text. Additional, natural language processing (NLP) can also be applied to assist the text recognition and to allow for server side AI analysis and data augmentation. At 425 the GPUimage is converted to a composite image and an update GPUimage at 445 is added to the composite image at 425. At 475 the GPUimage is re-rendered and the video is outputted at 475 to provide real-time video feedback to the user. At 450, items of a reference code, coordinate information and object data are detected and are uploaded to the server at 455 to create the online components with the coordinate information for positioning on the webpage created and for displaying the object data. The UI is generated with all the uploaded information and additional information from the server application from server side AI vision applications.

In an exemplary embodiment, SALESFORCE EINSTEIN™ is used to augment the data set uploaded. Using SALESFORCE EINSTEIN™ is a multistep process of the user collecting images which the use deems necessary to classify to classify. Then creating a dataset using the SALESFORCE EINSTEIN™ vision API, which stores the images used in the training model. Associated with the datasets are labels, which can be considered categories where an image that the user wants to identify may be group and a specified label attached. Once sufficient images are collected, the dataset may be trained, and the output is a trained model where additional images are validated and derived from different data sources, such as a file or URL, against this model which in turns allows for augmentation of the data set used in the online components on the webpage.

In addition, while the SWIFT™ detection application is used, other computer vision libraries may also be used. For example, Open source computer vision OPENCV™ is an example of one such library in which an open-source computer vision and machine learning software procedures are available and may be called in the present video capture processing. For example, in OPENCV™ a series of routines related to Canny Edge Detection, structuring of data elements, image dilation, and ascertaining the object contours are available for use in the capturing processes. Likewise, BOOTCV™ is another open source library for real-time computer vision applications BOOTCV™ is similarly organized into multiple types of routines for image processing, features, geometric vision, calibration, recognition, and input/output “IO”.

These computer vision applications also contain features such as the following: features for extraction algorithms for use in higher level operations; features for calibration which are routines for determining the camera's intrinsic and extrinsic parameters; features for recognition which are for recognition and tracking complex visual objects; features for geometric vision which is composed of routines for processing extracted image features using 2D and 3D geometry; features for visualize which has routines for rendering and displaying extracted features; and features for 10 which is for input and output routines for different data structures. A select subset of such features can be used in the image processing steps of the present disclosure to create among things the block images and perform the template reference code recognition.

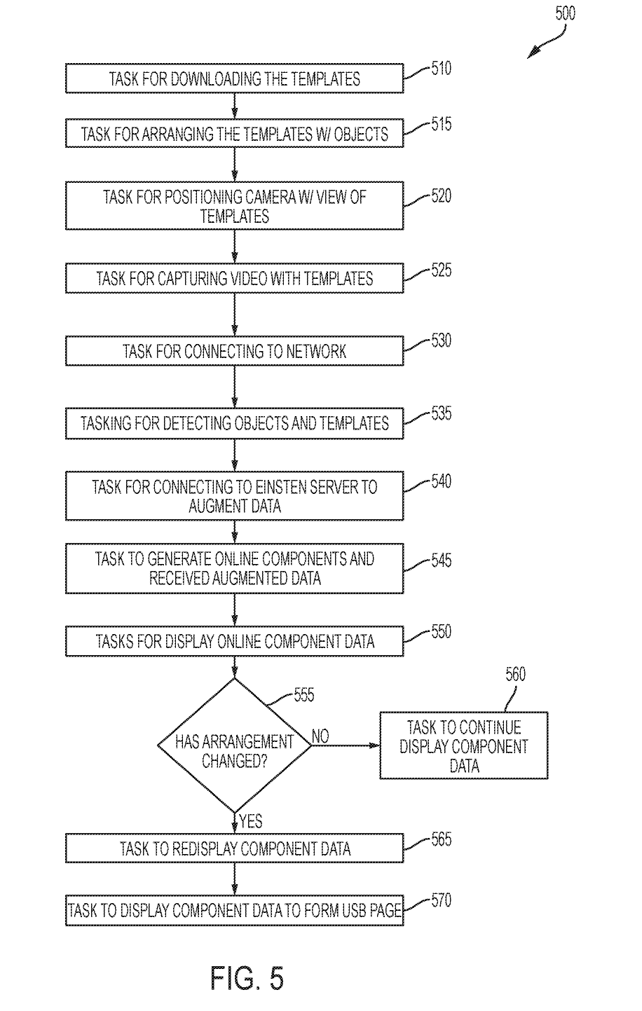

With a reference to FIG. 5, FIG. 5 illustrates an exemplary flowchart of a layout of the operation of the app creation methodology in accordance with an embodiment. Initially, at 510, the user selects a task from the app for downloading the templates of the components. The templates can be printed out and placed on a flat surface for capture by the camera. By placing the templates on a flat surface, skew corrections by the computer vision applications are reduced and features of the components of the templates are better identified. At 515, the user performs the task of arranging the templates with objects, in some instances the objects maybe three dimensional objects. The templates of the components are flexible and allow for the capture of a variety of media types and not simply written media. In other words, multimedia media maybe captured by the templates of the components printed out and various object data of video and audio can also be displayed and attached to the components. At 520, the user positions the camera with a field of the components. The camera at 525 communicates with the mobile client in operation which instructs the camera according to setting set by the user to capture the components of the template. The user may for example use wide angle settings or change the luminesce thresholds to better capture the components and identification information of the templates. In other words, the user can physically adjust the camera and the camera setting to enable better image capture of the features, identification information of the templates and the off-line component with the identification information as well as the objects attached to allow for better composing of the modules of the templates, components and objects when processed by the computer vision applications. In addition, the camera may be part of the mobile device hosting the mobile client or may be part of an interconnected device. Nevertheless, the camera which is operated that is capable of being able to communicate and providing images to the display of the mobile client and may also have capabilities for displaying the webpage processed on the server side. Generally, the camera provides video in the format of MPEG video streaming data but other similar alternatives may also be used.

At 535, detection algorithms are applied by the computer vision applications either on the client side or in instances the raw video may be sent via the cloud to a remote server for processing for detecting the objects and templates using in part the identification information of the components captured. At 540, after the detection of the components and objects off line, additional information may be added at this stage or a later stage to enrich or enhance the modules to be generated online. In an exemplary embodiment, the SALESFORCE EINSTEIN™ application may be com to search for and add related object information using artificial intelligent and machine language techniques. At 545, the online component is generated and any additional information is added to augment the data set of the online component and the data for displaying. In addition, the user may have the opportunity to further edit, replace, remove or change the online component generated. The online component is placed in the location designated by the X, Y coordinates received during the video capture. During the video capture task of 525 X, Y coordinates are extracted and this coordinate data is appropriately scaled to match a similar location to mirror the arrangement by the user during the video capture. For example, frames of the series of frames captures are temporally processed so that the coordinate information can be extracted. At 550, a task for executing the object data using the component type selected by the user by the template chosen is performed and the object data is displayed. As indicated earlier, the object data is multimedia data and is not limited to image data captured but may include video and audio captured or streamed from remote content providers where in such cases, the online components include appropriate APIs for connecting to the other applications providing the content. At 555, the create app checks whether the arrangement captures or being captured is unchanged, if unchanged the display of the online component at 560 is continued. If not, in a loop or feedback configuration, the task of displaying the online component at 565 is re-executed so the updated changes are shown in the online component being displayed. In other words, the user may in instances continue to make changes in the arrangement of the off-line components and templates and these changes are captured by the app create process at 565. At 570, the online components of all the object data are displayed in a manner that forms a webpage to the user viewing the collection of online components being displayed. In alternative embodiments, additional augmented data may be delivered to the mobile client in other communication paths such as SALESFORCE CHATTER®, instant messaging, email, or by various social networks.

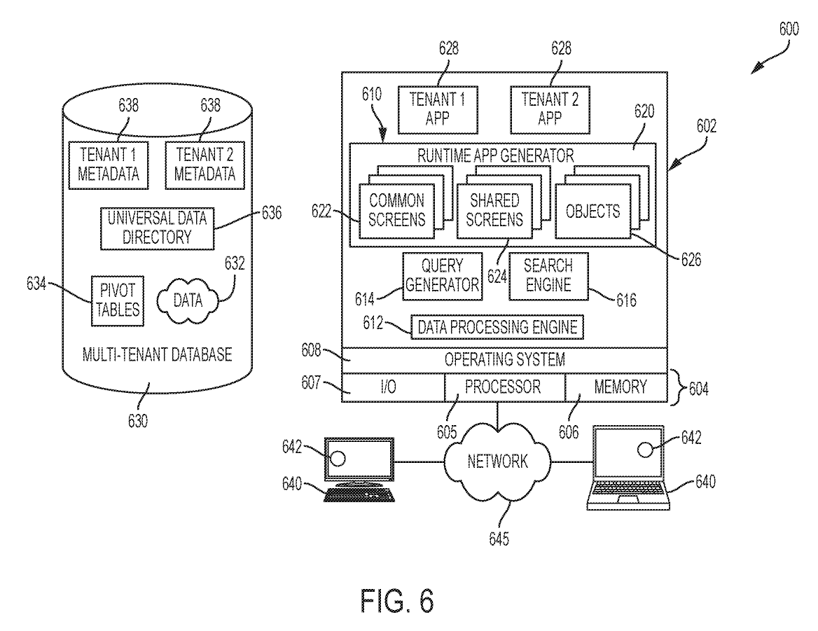

With a reference to FIG. 6, FIG. 6 is a schematic block diagram of a multi-tenant computing environment for use in conjunction with the communication process of the object sharing of the mobile client and agent in accordance with an embodiment. A server may be shared between multiple tenants, organizations, or enterprises, referred to herein as a multi-tenant database. In the exemplary disclosure, video-chat data and services are provided via a network 645 to any number of tenant devices 640, such as desk tops, laptops, tablets, smartphones, Google Glass™, and any other computing device implemented in an automobile, aircraft, television, or other business or consumer electronic device or system, including web tenants.

Each application 628 is suitably generated at run-time (or on-demand) using a common type of application platform 610 that securely provides access to the data 632 in the multi-tenant database 630 for each of the various tenant organizations subscribing to the service cloud 600. In accordance with one non-limiting example, the service cloud 600 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 630. In this regard, each tenant includes one or more users and/or groups associated with, authorized by, or otherwise belonging to that respective tenant. Stated another way, each respective user within the multi-tenant system of the service cloud 600 is associated with, assigned to, or otherwise belongs to a particular one of the plurality of enterprises supported by the system of the service cloud 600.

Each enterprise tenant may represent a company, corporate department, business or legal organization, and/or any other entities that maintain data for particular sets of users (such as their respective employees or customers) within the multi-tenant system of the service cloud 600. Although multiple tenants may share access to the server 602 and the multi-tenant database 630, the particular data and services provided from the server 602 to each tenant can be securely isolated from those provided to other tenants. The multi-tenant architecture therefore allows different sets of users to share functionality and hardware resources without necessarily sharing any of the data 632 belonging to or otherwise associated with other organizations.

The multi-tenant database 630 may be a repository or other data storage system capable of storing and managing the data 632 associated with any number of tenant organizations. The multi-tenant database 630 may be implemented using conventional database server hardware. In various embodiments, the multi-tenant database 630 shares the processing hardware 604 with the server 602. In other embodiments, the multi-tenant database 630 is implemented using separate physical and/or virtual database server hardware that communicates with the server 602 to perform the various functions described herein.

In an exemplary embodiment, the multi-tenant database 630 includes a database management system or other equivalent software capable of determining an optimal query plan for retrieving and providing a particular subset of the data 632 to an instance of application (or virtual application) 628 in response to a query initiated or otherwise provided by an application 628, as described in greater detail below. The multi-tenant database 630 may alternatively be referred to herein as an on-demand database, in that the multi-tenant database 630 provides (or is available to provide) data at run-time to on-demand virtual applications 628 generated by the application platform 610, as described in greater detail below.

In practice, the data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired. Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants.

Tenant-specific formatting, functions and other constructs may be maintained as tenant-specific metadata 638 for each tenant, as desired. Rather than forcing the data 632 into an inflexible global structure that is common to all tenants and applications, the multi-tenant database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data from the multi-tenant database 630.

The server 602 may be implemented using one or more actual and/or virtual computing systems that collectively provide the dynamic type of application platform 610 for generating the virtual applications 628. For example, the server 602 may be implemented using a cluster of actual and/or virtual servers operating in conjunction with each other, typically in association with conventional network communications, cluster management, load balancing and other features as appropriate. The server 602 operates with any sort of processing hardware 604 which is conventional, such as a processor 605, memory 606, input/output features 607 and the like. The input/output features 607 generally represent the interface(s) to networks (e.g., to the network 645, or any other local area, wide area or other network), mass storage, display devices, data entry devices and/or the like.

The processor 605 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 606 represents any non-transitory short or long term storage or other computer-readable media capable of storing programming instructions for execution on the processor 605, including any sort of random access memory (RAM), read only memory (ROM), flash memory, magnetic or optical mass storage, and/or the like. The computer-executable programming instructions, when read and executed by the server 602 and/or processors 605, cause the server 602 and/or processors 605 to create, generate, or otherwise facilitate the application platform 610 and/or virtual applications 628 and perform one or more additional tasks, operations, functions, and/or processes described herein. It should be noted that the memory 606 represents one suitable implementation of such computer-readable media, and alternatively or additionally, the server 602 could receive and cooperate with external computer-readable media that is realized as a portable or mobile component or platform, e.g., a portable hard drive, a USB flash drive, an optical disc, or the like.

The application platform 610 is any sort of software application or other data processing engine that generates the virtual applications 628 that provide data and/or services to the tenant devices 640. In a typical embodiment, the application platform 610 gains access to processing resources, communications interface and other features of the processing hardware 604 using any sort of conventional or proprietary operating system 608. The virtual applications 628 are typically generated at run-time in response to input received from the tenant devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the tenant devices 640. The virtual applications 628 are typically constructed in accordance with the tenant-specific metadata 638, which describes the particular tables, reports, interfaces and/or other features of the particular application 628. In various embodiments, each virtual application 628 generates dynamic web content that can be served to a browser or other tenant program 642 associated with its tenant device 640, as appropriate.

The runtime application generator 620 suitably interacts with the query generator 614 to efficiently obtain data 632 from the multi-tenant database 630 as needed in response to input queries initiated or otherwise provided by users of the tenant devices 140. In a typical embodiment, the query generator 614 considers the identity of the user requesting a particular function (along with the user's associated tenant), and then builds and executes queries to the multi-tenant database 630 using system-wide metadata 636, tenant specific metadata, pivot tables 634, and/or any other available resources. The query generator 614 in this example therefore maintains security of the common database by ensuring that queries are consistent with access privileges granted to the user and/or tenant that initiated the request.

With continued reference to FIG. 6, the bulk data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc.

In exemplary embodiments, the application platform 610 is utilized to create and/or generate data-driven virtual applications 628 for the tenants that they support. Such virtual applications 628 may make use of interface features such as custom (or tenant-specific) screens 624, standard (or universal) screens 622 or the like. Any number of custom and/or standard objects 626 may also be available for integration into tenant-developed virtual applications 628. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 632 associated with each virtual application 628 is provided to the multi-tenant database 630, as appropriate, and stored until it is requested or is otherwise needed, along with the metadata 638 that describes the particular features (e.g., reports, tables, functions, objects, fields, formulas, code, etc.) of that particular virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the multi-tenant database 630. In this regard, the object type defines the structure (e.g., the formatting, functions and other constructs) of each respective object 626 and the various fields associated therewith.

Still referring to FIG. 6, the data and services provided by the server 602 can be retrieved using any sort of personal computer, mobile telephone, tablet or other network-enabled tenant device 640 on the network 645. In an exemplary embodiment, the tenant device 640 includes a display device, such as a monitor, screen, or another conventional electronic display capable of graphically presenting data and/or information retrieved from the multi-tenant database 630, as described in greater detail below.

Typically, the user operates a conventional browser application or other tenant program 642 executed by the tenant device 640 to contact the server 602 via the network 645 using a networking protocol, such as the hypertext transport protocol (HTTP) or the like. The user typically authenticates his or her identity to the server 602 to obtain a session identifier (“Session ID”) that identifies the user in subsequent communications with the server 602. When the identified user requests access to a virtual application 628, the runtime application generator 620 suitably creates the application at run time based upon the metadata 638, as appropriate. However, if a user chooses to manually upload an updated file (through either the web based user interface or through an API), it will also be shared automatically with all of the users/devices that are designated for sharing.

As noted above, the virtual application 628 may contain Java, ActiveX, or other content that can be presented using conventional tenant software running on the tenant device 640; other embodiments may simply provide dynamic web or other content that can be presented and viewed by the user, as desired. As described in greater detail below, the query generator 614 suitably obtains the requested subsets of data 632 from the multi-tenant database 630 as needed to populate the tables, reports or other features of a particular virtual application 628. In various embodiments, application 628 embodies the functionality of an interactive performance review template linked to a database of performance metrics, as described below in a connection with FIGS. 1-5.

Techniques and technologies may be described herein in terms of functional and/or logical block components, and with a reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 6 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with viewing, object identification, sharing and information retrieving processes between the mobile client and agent in video-chat applications may be performed by software, hardware, firmware, or any combination thereof. For illustrative purposes, the following description of object capture, shared display, and process may refer to elements mentioned above in connection with FIGS. 1-6. In practice, portions of process of FIGS. 1-6 may be performed by different elements of the described system, e.g., mobile clients, agents, in-app applications etc.

It should be appreciated that process of FIGS. 1-6 may include any number of additional or alternative tasks, the tasks shown in FIGS. 1-6 need not be performed in the illustrated order, and process of the FIGS. 1-6 may be incorporated into a more comprehensive procedure or process having additional functionality not described in detail herein. Moreover, one or more of the tasks shown in FIG. 1-6 could be omitted from an embodiment of the process shown in FIGS. 1-6 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for determining functional roles of participants within an organization based on use by each participant of a software product for identifying a persona related to a participant role, said method comprising:
generating a survey for identifying a plurality of tasks performed by each participant using the software product independent of a role defined for the participant in an organization wherein the role has been previously defined based on a set of similar functionalities by the organization for the participant;
receiving data by the survey from a set of responses related to tasks of the participant use of the software product and not in accordance with the set of similar functionalities defined by the organization;
quantifying the data of the survey into clusters using algorithmic solutions for associating the clusters with core behaviors of each of the participants to redefine a role of the participant by tasks performed based on the participant use of the software product; and
determining, from a plurality of personas, a particular persona to be associated with each participant in accordance with a redefined role of the participant in the organization wherein the redefined role is based on results of associated core behaviors and related tasks performed of the participant.

2. A method of claim 1, wherein the software product comprises a software-as-a-service (SaaS) application.

3. The method of claim 1, wherein the software product comprises a cloud application.

4. The method of claim 1, further comprising:
receiving data of participants' use other than the survey data for quantifying into clusters with the survey data, and for associating with the core behaviors wherein the core behaviors are in turn associated with redefined roles of participants in the organization.

5. The method of claim 4, further comprising:
applying machine learning and artificial intelligent techniques to augment the survey data for better modeling of the redefined roles of the participants by use of machine learning and artificial intelligent applications to assist in both accentuating a data set of participant use for each participant and in formulating the redefined roles.

6. The method of claim 1, further comprising:
identifying time for one or more of each task of the plurality of tasks of participants in particular roles in the organization to differentiate participant roles based on time spent for each task and for allotting numerical scores for the time spent in association with a function of each task of the plurality of tasks identified.

7. The method of claim 1, further comprising:
identifying one or more personas from the plurality of personas for association with each of the participants wherein each participant is assigned a percentage contribution to an individual persona.

8. The method of claim 7, further comprising:
accessing knowledge databases or multi-tenant databases for data using artificial intelligence, machine learning and history of participant use to accentuate the individual persona.

9. A computer program product tangibly embodied in a computer-readable storage device and comprising instructions configurable to be executed by a processor to perform a method for determining functional roles of participants within an organization based on use by each participant of a software product for identifying a persona related to a participant role, the method comprising:
generating a survey for identifying a plurality of tasks performed by each participant using the software product independent of a role defined for the participant in an organization wherein the role has been previously defined based on a set of similar functionalities by the organization for the participant;
receiving data by the survey from a set of responses related to tasks of the participant use of the software product and not in accordance with the set of similar functionalities defined by the organization;
quantifying the data of the survey into clusters using algorithmic solutions for associating the clusters with core behaviors of each of the participants to redefine a role of the participant by tasks performed based on the participant use of the software product; and
determining, from a plurality of personas, a particular persona to be associated with each participant in accordance with a redefined role of the participant wherein the redefined role is based on results of associated core behaviors and related tasks performed of the participant in the organization.

10. The method of claim 9 wherein the software product comprises a software-as-a-service (SaaS) application.

11. The method of claim 9 wherein the software product comprises a cloud application.

12. The method of claim 9, further comprising:
receiving data of participants use other than the survey data for quantifying into clusters with the survey data, and for associating with the core behaviors wherein the core behaviors are in turn associated with redefined roles in the organization.

13. The method of claim 12, further comprising:
applying machine learning and artificial intelligent techniques to augment the survey data for better modeling of the redefined roles of the participants by use of machine learning and artificial intelligent applications to assist in both accentuating a data set of participant use for each participant and in formulating the redefined roles.

14. The method of claim 9 further comprising:
identifying time for one or more of each task of the plurality of tasks of participants in particular roles in the organization to differentiate participant roles based on time spent for each task and for allotting numerical scores for the time spent in association with a function of each task of the plurality of tasks identified.

15. The method of claim 9, further comprising:
identifying one or more personas from the plurality of personas for association with each of the participants wherein each participant is assigned a percentage contribution to an individual persona.

16. The method of claim 15, further comprising:
accessing knowledge databases or multi-tenant databases for data using artificial intelligence, machine learning and history of participant use to accentuate the individual persona.

17. A system comprising:
at least one processor; and
at least one computer-readable storage device comprising instructions configurable to be executed by the at least one processor to perform a method for identifying a persona of an employee of an organization by session use of a cloud application, the method comprising:
generating a survey for identifying a plurality of tasks performed by each employee using the cloud application independent of a role defined for the employee in an organization wherein the role has been previously defined based on a set of similar functionalities by the organization for the employee;
receiving data by the survey from a set of responses related to tasks of the participant use of the software product and not in accordance with the set of similar functionalities defined by the organization;
quantifying the data of the survey into clusters using algorithmic solutions for associating the clusters with core behaviors of each of the participants to redefine a role of the employee by tasks performed based on the employee use of the software product; and
determining, from a plurality of personas, a particular persona to be associated with each employee in accordance with a redefined role of the employee wherein the redefined role is based on results of associated core behaviors and related tasks performed of the employee in the organization.

18. The system of claim 17, further comprising:
receiving data of employee use other than the survey data for quantifying into clusters with the survey data, and for associating with the core behaviors wherein the core behaviors are in turn associated with redefined roles in the organization.

19. The system of claim 17, further comprising:
identifying time for one or more of each task of the plurality of tasks of employees in particular roles in the organization to differentiate employee roles based on time spent for each task and for allotting numerical scores for the time spent in association with a function of each task of the plurality of tasks identified.

20. The system of claim 17, further comprising:
identifying one or more personas from the plurality of personas for association with each of the employees wherein each employee is assigned a percentage contribution to an individual persona.
